(19) United States
(12) Patent Application Publication
(10) Pub. No.: US 2024/0001164 A1
(43) Pub. Date: Jan. 4, 2024

(54) METHOD, DEVICE AND SYSTEM OF A BLOCK SUBASSEMBLY INTEGRATED WITH ROUTING AND PIPING ELEMENTS ASSOCIATED WITH BREATHABLE AIR SUPPLIED TO A COMPONENT OF A FIREFIGHTER AIR REPLENISHMENT SYSTEM

(71) Applicants: Anthony J. Turiello, Westlake, TX (US); Aaron Patrick Jerabek, Wauwatosa, WI (US); Sean Eugene Cutting, Wood River Junction, RI (US)

(72) Inventors: Anthony J. Turiello, Westlake, TX (US); Aaron Patrick Jerabek, Wauwatosa, WI (US); Sean Eugene Cutting, Wood River Junction, RI (US)

(21) Appl. No.: 18/215,404

(22) Filed: Jun. 28, 2023

Related U.S. Application Data
(60) Provisional application No. 63/356,996, filed on Jun. 29, 2022.
(60) Provisional application No. 63/358,876, filed on Jul. 7, 2022.
(60) Provisional application No. 63/388,650, filed on Jul. 13, 2022.

(51) Int. Cl. A62B 9/04

(52) U.S. Cl. CPC A62B 9/04

(57) ABSTRACT

Disclosed are a method, a device and a system of a block subassembly associated with a component of a safety system of a structure. The block subassembly is provided with one or more input port(s) and one or more output port(s) on a main frame thereof. The block subassembly is coupled to the component of the safety system. The component is configured to receive breathable air from a source within the safety system via a fixed piping system implemented within the structure. Breathable air from the source is routed via the one or more input port(s) to the one or more output port(s) on the main frame of the block subassembly and then into the component of the safety system.

### CLAIM OF PRIORITY

This application is a conversion application of, and claims priority to, U.S. Provisional Patent Application No. 63/356,996 titled CLOUD-BASED FIREFIGHTING AIR REPLENISHMENT MONITORING SYSTEM, SENSORS AND METHODS filed on Jun. 29, 2022, U.S. Provisional Patent Application No. 63/358,876 titled LOOPED AIR PIPING ARCHITECTURE OF A FIREFIGHTER AIR REPLENISHMENT SYSTEM IN A HIGH RISE BUILDING TO ENABLE MULTIDIRECTIONAL FLOW TO FLOORS OF A BUILDING SUCH THAT BREATHABLE AIR TO IS DELIVERABLE TO ADJACENT FLOORS DESPITE COMPROMISED FLOORS DURING AN EMERGENCY filed on Jul. 7, 2022, and U.S. Provisional Patent Application No. 63/388,650 titled RINGED AIR PIPING ARCHITECTURE OF A FIREFIGHTER AIR REPLENISHMENT SYSTEM IN A BIG BOX CONSTRUCTION TO ENABLE MULTIDIRECTIONAL FLOW TO REGIONS OF A LARGE BUILDING SUCH THAT BREATHABLE AIR TO IS DELIVERABLE TO REGIONS SURROUNDING COMPROMISED AREAS OF THE LARGE BUILDING DURING AN EMERGENCY filed on Jul. 13, 2022.

The contents of each of the aforementioned applications are incorporated herein by reference in entirety thereof.

### FIELD OF TECHNOLOGY

This disclosure relates generally to emergency systems and, more particularly, to a method, a device and/or a system of a block subassembly integrated with routing and piping elements associated with breathable air supplied to a component of a safety system of a structure.

### BACKGROUND

A structure (e.g., a vertical building, a horizontal building, a tunnel, marine craft) may have a Firefighter Air Replenishment System (FARS) implemented therein. The FARS may have an emergency air fill station therein to enable firefighters and/or emergency personnel access breathable air therethrough. Also, the FARS may include an air monitoring system to monitor parameters of the breathable air. For the aforementioned purpose, each of the emergency air fill station and the air monitoring system may require an air connection to the breathable air in the FARS. In addition, the emergency air fill station and/or the air monitoring system may require a power connection and/or communication routing (e.g., radio communication, communication in a Distributed Antenna System (DAS) implemented in the FARS) within the FARS. Coupling the emergency air fill station and/or the air monitoring system to a fixed piping system implemented within the FARS for the supply of breathable air therewithin and/or the DAS/a power unit may provide for an unstable and/or an inefficient air connection and/or communication routing.

### SUMMARY

Disclosed are a method, a device and/or a system of a block subassembly integrated with routing and piping elements associated with breathable air supplied to a component of a safety system of a structure.

In one aspect, a method of a safety system of a structure having a fixed piping system implemented therein to supply breathable air from a source across the safety system is disclosed. The method includes providing a block subassembly including one or more input port(s) and one or more output port(s) on a main frame thereof coupled to a component of the safety system. Also, the method includes routing the breathable air from the source via the one or more input port(s) to the one or more output port(s) on the main frame of the block subassembly and then into the component of the safety system.

In another aspect, a component of a safety system of a structure configured to receive breathable air from a source within the safety system via a fixed piping system implemented therein is disclosed. The component includes a surface including an inlet port, and a block subassembly including a main frame coupled to the surface. The main frame includes one or more input port(s) and one or more output port(s) provided thereon. The breathable air from the source is routed through the one or more input port(s) to the one or more output port(s), and from the one or more output port(s) into the inlet port of the surface of the component.

In yet another aspect, a safety system of a structure includes a component including an inlet port on a surface thereof, a fixed piping system implemented within the structure for supply of breathable air from a source to the component, and a block subassembly associated with the component. The block subassembly includes a main frame coupled to the surface of the component. The main frame includes one or more input port(s) and one or more output port(s) provided thereon. The breathable air from the source is routed through the one or more input port(s) to the one or more output port(s), and from the one or more output port(s) into the inlet port on the surface of the component.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic and an illustrative view of a safety system associated with a structure, according to one or more embodiments.

FIG. 2 is a schematic and an illustrative view of an emergency air fill panel as an example emergency air fill station of the safety system of FIG. 1.

FIG. 3 is a schematic and an illustrative view of a rupture containment air fill station as another example emergency air fill station of the safety system of FIG. 1.

FIG. 4 is an illustrative view of a block subassembly integrated with an emergency air fill station or an air monitoring system of the safety system of FIGS. 1-3, according to one or more embodiments.

FIG. 5 is an illustrative view of routing of breathable air between an input port and an output port of a main frame of the block subassembly of FIG. 4 through a piping element, according to one or more embodiments.

FIG. 6 is a schematic view of specific components of the safety system of FIG. 1, according to one or more embodiments.

FIG. 7 is a process flow diagram detailing the operations involved in realizing a block subassembly integrated with routing and piping elements associated with breathable air supplied to a component of a safety system of a structure, according to one or more embodiments.

FIG. 8 is a schematic view of an example manifold feature expansion effectible through the safety system of FIGS. 1 and 6 using the block subassembly of FIGS. 4-5.

Other features of the present embodiments will be apparent from the accompanying drawings and from the detailed description that follows.

### DETAILED DESCRIPTION

Example embodiments, as described below, may be used to provide a method, a device and/or a system of a block subassembly integrated with routing and piping elements associated with breathable air supplied to a component of a safety system of a structure. Although the present embodiments have been described with reference to specific example embodiments, it will be evident that various modifications and changes may be made to these embodiments without departing from the broader spirit and scope of the various embodiments.

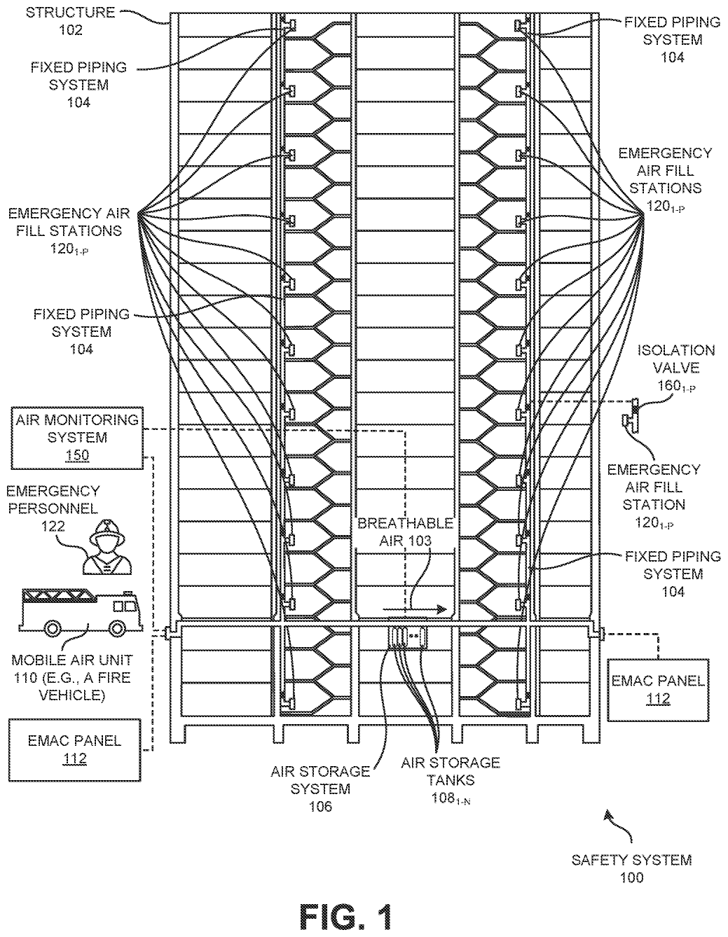

FIG. 1 shows a safety system 100 associated with a structure 102, according to one or more embodiments. In one or more embodiments, safety system 100 may be a Firefighter Air Replenishment System (FARS) to enable firefighters entering structure 102 in times of fire-related emergencies to gain access to breathable (e.g., human breathable) air (e.g., breathable air 103) in-house without the need of bringing in air bottles/cylinders to be transported up several flights of stairs of structure 102 or deep thereinto, or to refill depleted air bottles/cylinders that are brought into structure 102. In one or more embodiments, safety system 100 may supply breathable air provided from a supply of air tanks (to be discussed) stored in structure 102. When a fire department vehicle arrives at structure 102 during an emergency, breathable air supply typically may be provided through a source of air connected to said vehicle. In one or more embodiments, safety system 100 may enable firefighters to refill air bottles/cylinders thereof at emergency air fill stations (to be discussed) located throughout structure 102. Specifically, in some embodiments, firefighters may be able to fill air bottles/cylinders thereof at emergency air fill stations within structure 102 under full respiration in less than one to two minutes.

In one or more embodiments, structure 102 may encompass vertical building structures, horizontal building structures (e.g., shopping malls, hypermarts, extended shopping, storage and/or warehousing related structures), tunnels, marine craft (e.g., large marine vessels such as cruise ships, cargo ships, submarines and large naval craft, which may be “floating” versions of buildings and horizontal structures) and mines. Other structures are within the scope of the exemplary embodiments discussed herein. In one or more embodiments, safety system 100 may include a fixed piping system 104 permanently installed within structure 102 serving as a constant source of replenishment of breathable air 103. Fixed piping system 104 may be regarded as being analogous to a water piping system within structure 102 or another structure analogous thereto for the sake of imaginative convenience.

As shown in FIG. 1, fixed piping system 104 may distribute breathable air 103 across floors/levels of structure 102. For the aforementioned purpose, fixed piping system 104 may distribute breathable air 103 from an air storage system 106 (e.g., within structure 102) including a number of air storage tanks 108_{1-N} that serve as sources of pressurized/compressed air (e.g., breathable air 103). Additionally, in one or more embodiments, fixed piping system 104 may interconnect with a mobile air unit 110 (e.g., a fire vehicle) through an External Mobile Air Connection (EMAC) panel 112.

In one or more embodiments, EMAC panel 112 may be a boxed structure (e.g., exterior to structure 102) to enable the interconnection between mobile air unit 110 and safety system 100. For example, mobile air unit 110 may include an on-board air compressor to store and replenish pressurized/compressed air (e.g., breathable air analogous to breathable air 103) in air bottles/cylinders (e.g., utilizable with Self-Contained Breathing Apparatuses (SCBAs) carried by firefighters). Mobile air unit 110 may also include other pieces of air supply/distribution equipment (e.g., piping and/or air cylinders/bottles) that may be able to leverage the sources of breathable air 103 within safety system 100 through EMAC panel 112. Firefighters, for example, may be able to fill breathable air (e.g., breathable air 103, breathable air analogous to breathable air 103) into air bottles/cylinders (e.g., spare bottles, bottles requiring replenishment of breathable air) carried on mobile air unit 110 through safety system 100.

In FIG. 1, EMAC panel 112 is shown at two locations merely for the sake of illustrative convenience. In one or more embodiments, an air monitoring system 150 may be installed as part of safety system 100 to automatically track and monitor a parameter (e.g., pressure) and/or a quality (e.g., indicated by moisture levels, carbon monoxide levels) of breathable air 103 within safety system 100. FIG. 1 shows air monitoring system 150 as communicatively coupled to air storage system 106 and EMAC panel 112 merely for the sake of example. It should be noted that EMAC panel 112 may be at a remote location associated with (e.g., internal to, external to) structure 102. In one or more embodiments, for monitoring the parameters and/or the quality of breathable air within safety system 100, air monitoring system 150 include appropriate sensors and circuitries therein. For example, a pressure sensor (to be discussed) within air monitoring system 150 may automatically sense and record a pressure of breathable air 103 of safety system 100. Said pressure sensor may communicate with an alarm system that is triggered when the sensed pressure is outside a safety range. Also, in one or more embodiments, air monitoring system 150 may automatically trigger a shutdown of breathable air distribution through safety system 100 in case of impurity/contaminant (e.g., carbon monoxide) detection therethrough yielding levels above a safety/predetermined threshold.

In one or more embodiments, fixed piping system 104 may include pipes (e.g., constituted out of stainless steel tubing) that distribute breathable air 103 to a number of emergency air fill stations 120₁₋ₚ within structure 102. In one example implementation, each emergency air fill station 120₁₋ₚ may be located at a specific level of structure 102. If structure 102 is regarded as a vertical building structure, an emergency air fill station 120₁₋ₚ may be located at each of a basement level, a first floor level, a second floor level and so on. For example, emergency air fill station 120₁₋ₚ may be located at the end of the flight of stairs that emergency fighting personnel (e.g., firefighting personnel) need to climb to reach a specific floor level within the vertical building structure.

In one or more embodiments, an emergency air fill station 120₁₋ₚ may be a static location within a level of structure 102 that provides emergency personnel 122 (e.g., firefighters, emergency responders, maintenance personnel) with the ability to rapidly fill air bottles/cylinders (e.g., SCBA cylinders) with breathable air 103. In one or more embodiments, emergency air fill station 120₁₋ₚ may be an emergency air fill panel or a rupture containment air fill station. In one or more embodiments, proximate each emergency air fill station 120₁₋ₚ, safety system 100 may include an isolation valve 160₁₋ₚ to isolate a corresponding emergency air fill station 120₁₋ₚ from a rest of safety system 100. For example, said isolation may be achieved through the manual turning of isolation valve 160₁₋ₚ proximate the corresponding emergency air fill station 120₁₋ₚ or remotely (e.g., based on automatic turning) from air monitoring system 150. In one example implementation, air monitoring system 150 may maintain breathable air supply to a subset of emergency air fill stations 120₁₋ₚ via fixed piping system 104 through control of a corresponding subset of isolation valves 160₁₋ₚ and may isolate the other emergency air fill stations 120₁₋ₚ from the breathable air supply. It should be noted that configurations and components of safety system 100 may vary from the example safety system 100 of FIG. 1.

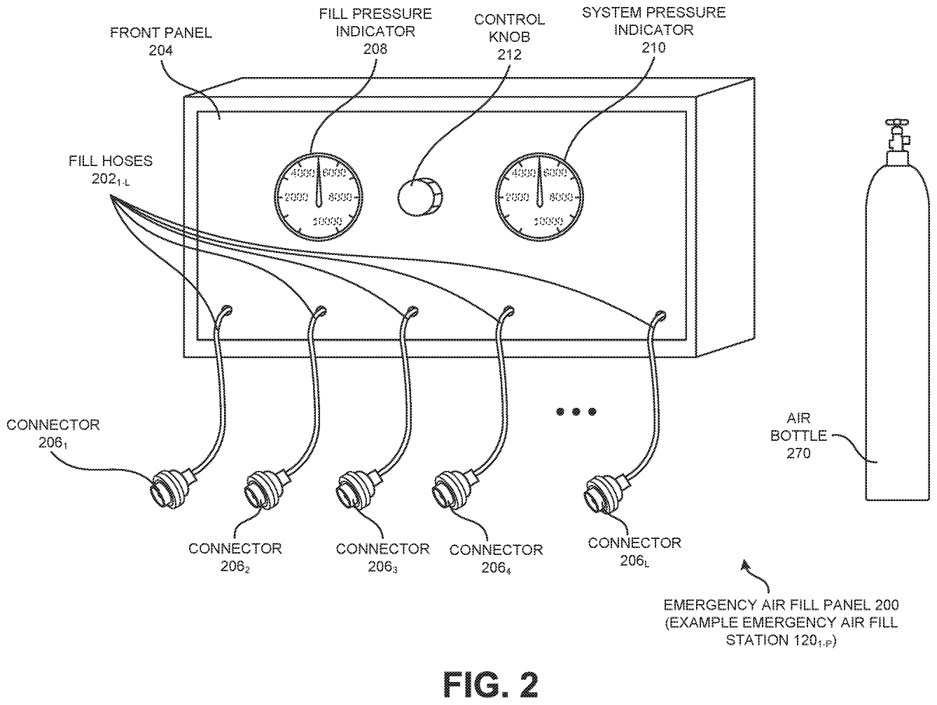

FIG. 2 shows an emergency air fill panel 200 as an example emergency air fill station 120₁₋ₚ, according to one or more embodiments. In one or more embodiments, emergency air fill panel 200 may enable emergency personnel 122 (e.g., firefighters, emergency responders, maintenance personnel) to rapidly fill air bottles/cylinders thereof through the use of connectors. In one or more embodiments, a number of fill hoses 202_{1-L} may protrude from a front panel 204 of emergency air fill panel 200; each of said fill hoses 202_{1-L} may have a connector 206_{1-L}, (e.g., a Rapid Intervention Crew Universal Air Coupling (RIC/UAC) connector) at an end (e.g., free end) thereof not attached to front panel 204. In one or more embodiments, emergency air fill panel 200 may be directly coupled (e.g., connected) to air bottles/cylinders by way of connectors 206_{1-L}. In one or more embodiments, emergency air fill panel 200 may also include a fill pressure indicator 208 (e.g., a pressure gauge) to indicate a pressure (e.g., a standard pressure) to which an air bottle/cylinder may be filled, a system pressure indicator 210 to indicate a current pressure level of breathable air 103 in safety system 100, and a control knob 212 to adjust the pressure to which the air bottle/cylinder may be filled such that said pressure does not exist a safety threshold thereof (e.g., the safety threshold that safety system 100 may be designed for).

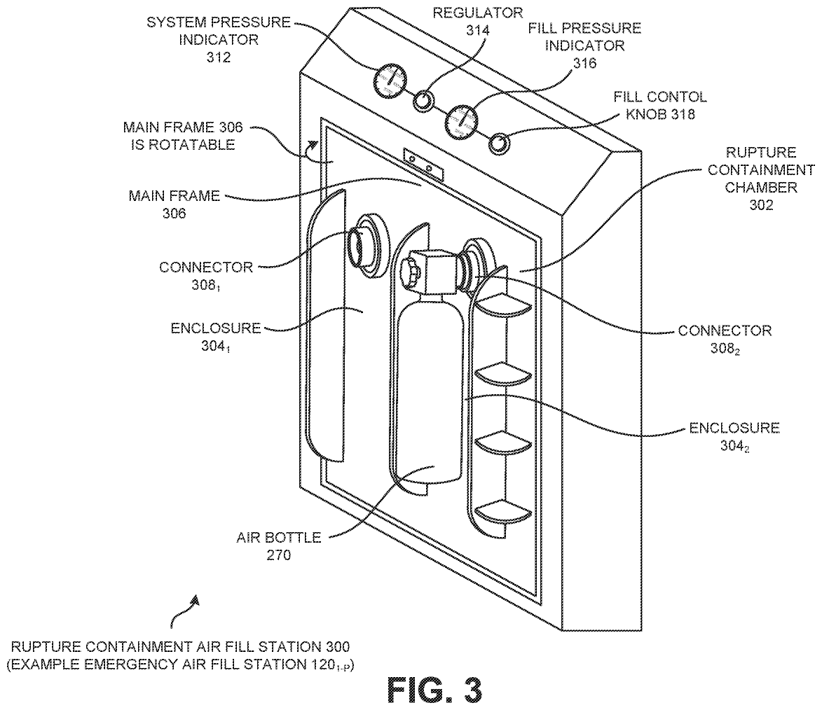

In one or more embodiments, connecting emergency air fill panel 200 to air bottles/cylinders through fill hoses 202_{1-L} thereof may enable precious time to be saved on behalf of emergency personnel 122 (e.g., firefighters, maintenance personnel, emergency responders) who, without capabilities therefor, need to remove emergency equipment from rescue attires thereof before being supplied with breathable air 103. FIG. 3 shows a rupture containment air fill station 300 as another example emergency air fill station 120₁₋ₚ, according to one or more embodiments. In one or more embodiments, rupture containment air fill station 300 may constitute a rupture containment chamber that facilitates shielding of over-pressurized air cylinders/bottles and containment thereof within the rupture containment chamber to prevent injuries due to bursts/ruptures thereof. As seen in FIG. 3, in one or more embodiments, rupture containment air fill station 300 may include a rupture containment chamber 302 with specific enclosures 304₁₋₂ for accommodating air cylinders/bottles therewithin. In one or more embodiments, each enclosure 304₁₋₂ may provide space to accommodate an air cylinder/bottle therewith by way of the air cylinder/bottle being connected to rupture containment air fill station 300.

In one or more embodiments, rupture containment chamber 302 may have a main frame 306 thereof that includes a connector 308₁₋₂ (e.g., analogous to connectors 206_{1-L}) provided within or proximate each enclosure 304₁₋₂. As shown in FIGS. 2-3, a connector 206_{1-L}/connector 308₁₋₂ may be utilized to couple an air bottle 270 to emergency air fill panel 200/rupture containment air fill station 300 to enable filling (or replenishment) thereof with breathable air 103. In one or more embodiments, main frame 306 may be rotatable such that, upon rotation, main frame 306 with air bottle 270 within an enclosure 304₁₋₂ may be isolated from an external environment of rupture containment air fill station 300. In one or more embodiments, in this state of isolation, air bottle 270 may not be visible or not face emergency personnel 122 in front of rupture containment air fill station 300.

In one or more embodiments, as seen in FIG. 3, rupture containment air fill station 300 may include a system pressure indicator 312 (e.g., analogous to system pressure indicator 210) indicating the pressure level at which breathable air 103 is being delivered through safety system 100, a regulator 314 to adjust the pressure of the source (e.g., air storage system 106) of the compressed breathable air (e.g., breathable air 103) to ensure that said pressure may not exceed a design pressure of safety system 100, a fill pressure indicator 316 (e.g., analogous to fill pressure indicator 208) to indicate a pressure (e.g., a standard pressure) to which air bottle 270 may be filled, and a fill control knob 318 (e.g., analogous to control knob 212) to control the pressure to which air bottle 270 may be filled such that said pressure does not exceed a safety threshold thereof within safety system 100.

It should be noted that FIG. 3 merely shows two enclosures 304₁₋₂ and two connectors 308₁₋₂ for the sake of illustrative convenience and that any number of enclosures and connectors are within the scope of the exemplary embodiments discussed herein. The same thing may also apply to FIG. 2 and the number of fill hoses 202_{1-L} and connectors 206_{1-L} in emergency air fill panel 200. Also, it should be noted that the components of emergency air fill panel 200 and rupture containment air fill station 300, and layouts, distribution and the numbers thereof may vary. FIGS. 2 and 3 merely illustrate an example emergency air fill panel 200 and a rupture containment air fill station 300 respectively. It should further be noted that all kinds of emergency air fill stations 120₁₋ₚ are within the scope of the exemplary embodiments discussed herein.

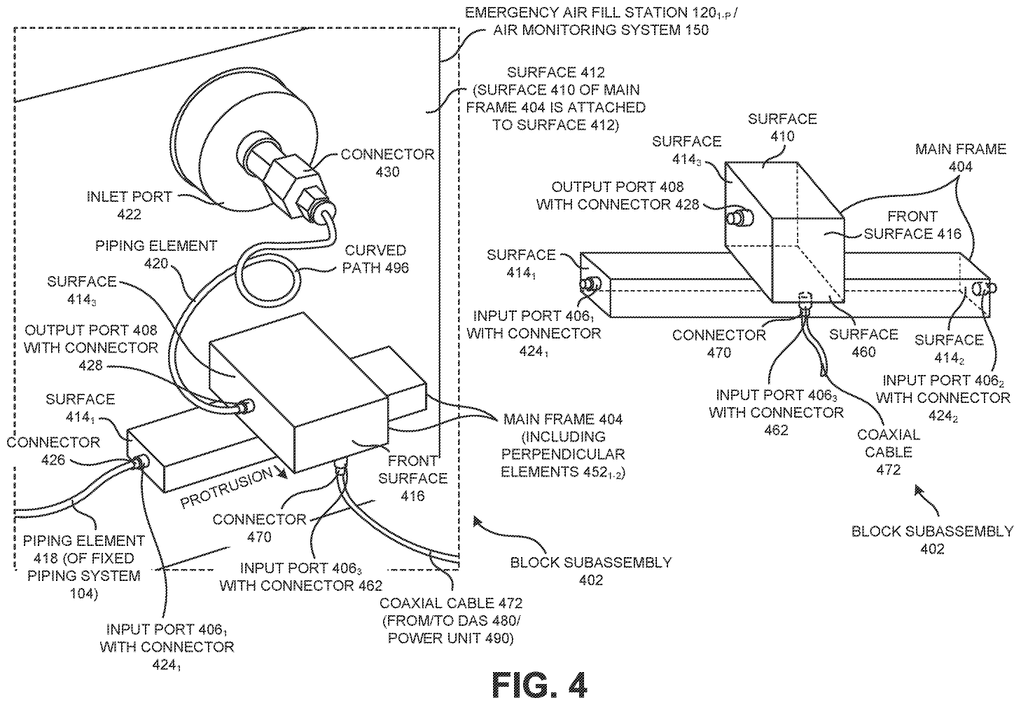

FIG. 4 shows a block subassembly 402 integrated with an emergency air fill station 120₁₋ₚ (e.g., emergency air fill panel 200, rupture containment air fill station 300) or an air monitoring system 150 of safety system 100, according to one or more embodiments. In one or more embodiments, air monitoring system 150 may be a component of safety system 100 with electrical, mechanical and/or electronic components integrated with one another to realize functionalities associated with monitoring breathable air 103. For the aforementioned purpose, in one or more embodiments, air monitoring system 150 may include one or more sensors (not shown) (e.g., air parameter sensors such as carbon dioxide sensors, carbon monoxide sensors, hydrocarbon sensors, flow sensors, temperature sensors and pressure sensors; other kinds of sensors may also be possible). While block subassembly 402 discussed herein preferentially may be integrated with emergency air fill station 120₁₋ₚ, integration thereof with other components of safety system 100 not limited to air monitoring system 150 is also within the scope of the exemplary embodiments discussed herein.

As seen in FIG. 4, block subassembly 402 may include a T-shaped main frame 404 including one or more input ports 406₁₋₃ (note that three input ports have merely been shown for the sake of example) and one or more output ports (e.g., only one output port 408 is shown for example purposes). In one or more embodiments, main frame 404 may be made of a metal (e.g., an oxide coated metal), a metal alloy and/or a composite material. In a state of direct coupling/attachment of a surface 410 of main frame 404 of block subassembly 402 to a surface 412 (e.g., of a back panel/back frame) of emergency air fill station 120₁₋ₚ/air monitoring system 150, surfaces 414₁₋₃ of main frame 404 may be perpendicular to a front surface 416 of main frame 404 that is parallel to both surface 412 of emergency air fill station 120₁₋ₚ/air monitoring system 150 and surface 410. In one implementation, each of surfaces 414₁₋₃ may be provided with input/output ports. For example, surface 414₁ may include an input port 406₁ configured to receive a piping element 418 (e.g., a stainless steel tube) of fixed piping system 104 supplying breathable air 103 from air storage system 106.

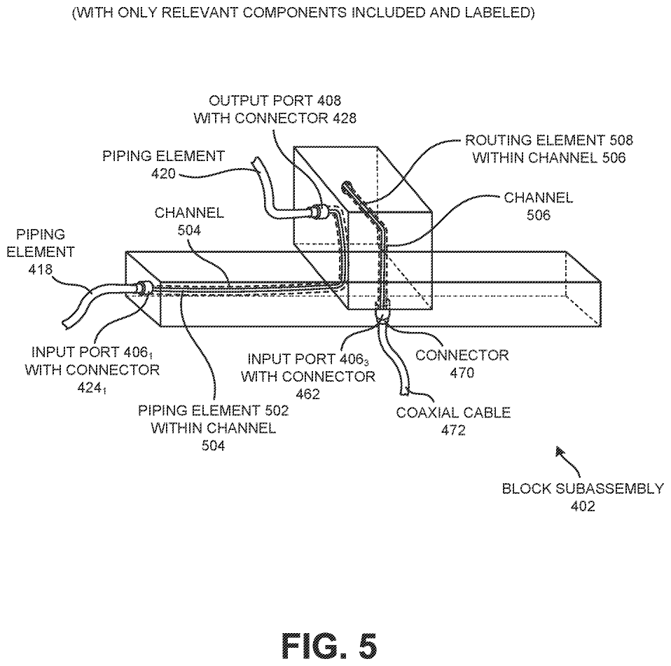

In one or more embodiments, as will be seen in FIG. 5, input port 406₁ may be utilized to route breathable air 103 to output port 408 provided on surface 414₃ within main frame 404. In one or more embodiments, another piping element 420 may supply breathable air 103 from output port 408 to an inlet port 422 provided on surface 412 of emergency air fill station 120₁₋ₚ/air monitoring system 150. In one or more implementations, said inlet port 422 may be made of stainless steel. Other possibilities thereof are within the scope of the exemplary embodiments discussed herein. In FIG. 4, input port 406₂ may be provided on surface 414₂ and may again be utilized (e.g., as a spare port) to receive breathable air 103 from fixed piping system 104. FIG. 4 shows input port 406₂ as not being coupled to anything for the sake of illustrating the “reserve” status thereof.

In one or more embodiments, each input port 406₁₋₂ may include a connector 424₁₋₂ that forms part of a coaxial connection with another connector (e.g., connector 426) associated with piping element 418 by way of piping element 418. Further, in one or more embodiments, output port 408 may include another connector 428 that forms part of another coaxial connection with piping element 420; piping element 420 may also be coupled to a connector 430 of inlet port 422 of emergency air fill station 120₁₋ₚ/air monitoring system 150 by way of yet another coaxial connection. In some implementations, connector 430 may be associated with piping element 420 instead. It should be noted that a connector analogous to connector 426 may be provided on piping element 420 to complete the aforementioned another coaxial connection.

It should be noted that the coaxial connection discussed herein with respect to the connectors (e.g., connector 430, connector 428, connector 426, connector 424₁₋₂) should not be considered as limiting. All possible types of wired connections for communication are within the scope of the exemplary embodiments discussed herein.

As shown in FIG. 4, main frame 404 may include two elements 452₁₋₂ perpendicular to and intersecting one another to form the T shape discussed above. Element 452₁ may be the one with output port 408; said element 452₁ may intersect with element 452₂ and protrude outward at a location of the intersection for a thickness higher than that of element 452₂. On a surface 460 of the protrusion also perpendicular to front surface 416 of main frame 404, input port 406₃ may be provided. In one or more embodiments, said input port 406₃ may include a connector 462 configured to form yet another coaxial connection with a connector 470 of a coaxial cable 472. In some implementations, said coaxial cable 472 may route communication between a Distributed Antenna System (DAS) 480 of safety system 100 and emergency air fill station 120₁₋ₚ/air monitoring system 150. In some other implementations, coaxial cable 472 may be a power cable supplying electric power from a power unit 490 of safety system 100.

Again, it should be noted that the coaxial connection discussed above should not be considered limiting. Connector 470 and coaxial cable 472 may instead be components of other types of wired or wireless communication. Further, DAS 480 has been shown merely for example purposes. DAS 480 as discussed herein, may be a mobile DAS employed within structure 102 and safety system 150 to enable communication (e.g., signal based communication) between emergency personnel 122, mobile towers and/or air monitoring system 150/emergency air fill stations 120₁₋ₚ. DAS 480 may descriptively be a network of spatially separated antenna nodes connected to a common source via a transport medium that provides wireless service within a geographical area or structure (e.g., structure 102). In one or more embodiments, an emergency air fill station 120₁₋ₚ may include a node in DAS 480. All reasonable variations are within the scope of the exemplary embodiments discussed herein.

FIG. 5 shows routing of breathable air 103 between input port 406₁ and output port 408 through a piping element 502 analogous to piping element 418 and piping element 420, according to one or more embodiments. For the aforementioned purpose, channels (e.g., channel 504) may be provided (e.g., cut/shaped within) within main frame 404 (shown as transparent merely for the sake of illustration). Similarly, a channel 506 (e.g., cut/shaped within main frame 404) may be provided for routing communication (e.g., radio, electronic, electrical; through routing element 508 (e.g., an electrical element) within main frame 404) to emergency air fill station 120₁₋ₚ/air monitoring system 150. All reasonable variations are within the scope of the exemplary embodiments discussed herein.

It should be noted that coaxial cable 472 discussed herein may be fire-rated (or fire resistance-rated). Further, all possible locations of input ports 406₁₋₃ and output port 408 on main frame 404 are within the scope of the exemplary embodiments discussed herein. In one or more embodiments, block subassembly 402 discussed herein may serve as a module removably attachable to emergency air fill station 120₁₋ₚ/air monitoring system 150 to enable efficient and quick coupling of breathable air 103 and/or routing of communication/power from DAS 480/power unit 490 thereto; even the coupling of power/communication from DAS 480 and breathable air 103 from fixed piping system 104 to emergency air fill station 120₁₋ₚ/air monitoring system 150 may be removable and configurable without interfering with emergency air fill station 120₁₋ₚ/air monitoring system 150 therefor. Moreover, in one or more embodiments, the perpendicularity between elements 452₁₋₂ and utilization of piping elements (418, 420, 502) through connectors (424₁₋₂, 428) may provide for a stable air connection. Also, in one or more embodiments, as shown in FIG. 4, piping element 420 may offer a curved path 496 to breathable air 103 flowing therethrough to provide for increased mechanical stability of the air connection.

Further, in one or more embodiments, block subassembly 402 with integrated routing (e.g., routing element 508) and piping elements (e.g., piping element 418, piping element 420, piping element 502) may simplify manufacturing and/or assembly of emergency air fill station 120₁₋ₚ/air monitoring system 150. Still further, in one or more embodiments, surface based mating between block subassembly 402 and specific components of safety system 100 should not be considered limiting. Concepts discussed herein may extend to other forms of coupling (e.g., tubing based) between block subassembly 402 and the specific components of safety system 100. Last but not the least, the shape of main frame 404 discussed above must not be considered limiting. Multiple Ts (not shown) for increased input/output ports and other configurations are within the scope of the exemplary embodiments discussed herein.

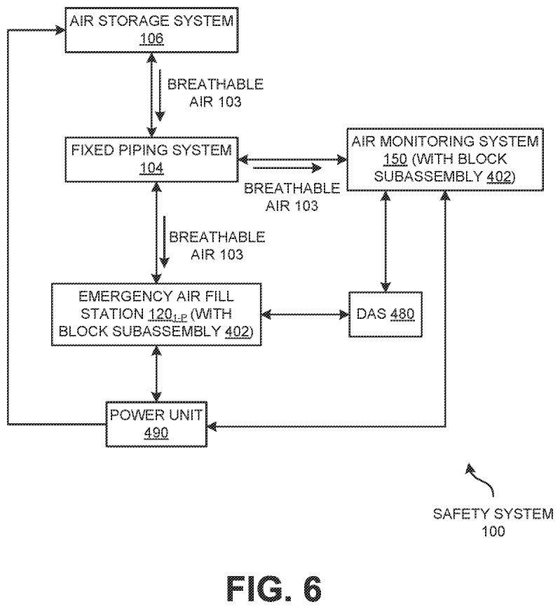

FIG. 6 shows specific components (e.g., air monitoring system 150, emergency air fill station 120₁₋ₚ) of safety system 100 to provide context to the discussion above. As discussed above, fixed piping system 104 and DAS 480 (and even power unit 490) implemented within safety system 100 may both be coupled to each of air monitoring system 150 and emergency air fill station 120₁₋ₚ Each of air monitoring system 150 and emergency air fill station 120₁₋ₚ has been shown as being attached with block subassembly 402 in FIG. 6 for example purposes. All reasonable variations are within the scope of the exemplary embodiments discussed herein.

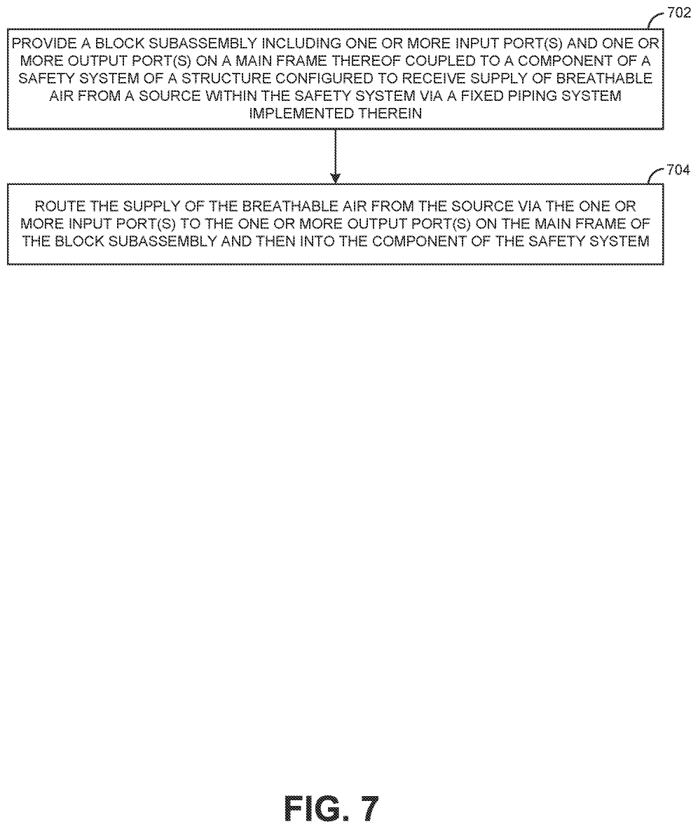

FIG. 7 shows a process flow diagram detailing the operations involved in realizing a block subassembly (e.g., block subassembly 402) integrated with routing and piping elements associated with breathable air (e.g., breathable air 103) from a source (e.g., air storage system 106) supplied to a component (e.g., emergency air fill station 120₁₋ₚ, air monitoring system 150) of a safety system (e.g., safety system 100) of a structure (e.g., structure 102) via a fixed piping system (e.g., fixed piping system 104) implemented therein, according to one or more embodiments. In one or more embodiments, operation 702 may involve providing the block subassembly with one or more input port(s) (e.g., input ports 406₁₋₃) and one or more output port(s) (e.g., output ports 408) on a main frame (e.g., main frame 404) thereof coupled to the component of the safety system. In one or more embodiments, operation 704 may then involve routing the breathable air from the source via the one or more input port(s) to the one or more output port(s) on the main frame of the block subassembly and then into the component of the safety system.

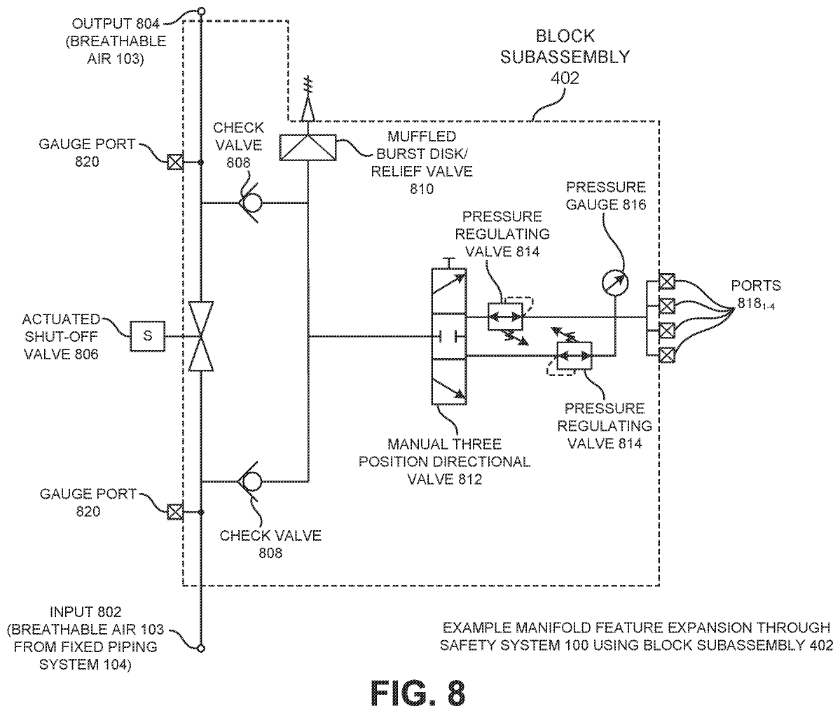

FIG. 8 shows an example manifold feature expansion effectible through safety system 100 using block subassembly 402. Here, for example, an input port 406₁₋₃ (e.g., a high-pressure port; 5500 Pounds Per Square Inch (PSI), 6500 PSI of pressure) of block subassembly 402 may have breathable air 103 from fixed piping system 104 as an input 802 thereinto. For example, input 802 may be provided at predefined locations (e.g., emergency air fill stations 120₁₋ₚ at levels within structure 102) within safety system 100 for ease of installation. In other words, each emergency air fill station 120₁₋ₚ may be provided with block subassembly 402 for feature expansion therethrough. In one example implementation, an electronically actuated shut-off valve 806 may be provided within emergency air fill station 120₁₋ₚ (or another component of safety system 100 if required; on emergency air fill station 120₁₋ₚ or external thereto may also be possible) to improve safety within safety system 100. For example, the flow of breathable air 103 may be stopped (e.g., based on detection of hazardous/impure content therein) or continued and/or individual subsystems (e.g., one or more levels of safety system 100) isolated from supply of breathable air 103 using actuated shut-off valve 806. Thus, in some embodiments, actuated shut-off valve 806 may indicate operational status (e.g., supply of breathable air 103 within) of safety system 100 (and/or of the relevant component thereof) and, thereby, of safety thereof.

It should be noted that fixed piping system 104 may have one or more loop piping arrangements therewithin. At least for supporting the aforementioned arrangement, the configuration discussed in FIG. 8 may include check valves (e.g., check valves 808; check valves may allow for flow of breathable air 103 only through one direction) coupled across actuated shut-off valve 806. Additionally, check valves 808 may also be indicative of operational status (e.g, supply of breathable air 103 within) of safety system 100 (and/or of the relevant component thereof) and, thereby, of safety thereof. The configuration may also include a muffled burst disk/relief valve 810 coupled across actuated shut-off valve 806 (and, if present, check valves 808) to protect emergency air fill station 120₁₋ₚ or another component of safety system 100 from overpressurization due to any pressure differential of breathable air 103. The muffle burst disk may be a sacrificial part that fails at a predetermined differential by, for example, rupturing or bursting. The relief valve may be set to open at a predetermined pressure level to protect the relevant component of safety system 100.

Check valves 808 and/or muffled burst disk/relief valve 810 may be provided within, on or outside a component (e.g., an emergency air fill station 120₁₋ₚ) of safety system 100. Manual three position directional valve 812 may be coupled to the aforementioned valve configuration to enable emergency personnel 122 select between different pressures (e.g., 4500 PSI, 5500 PSI) of breathable air 103 as per a requirement of an air bottle 270 (or, breathable air cylinder in general) thereof. The three position directional valve is merely an example. Other valves are within the scope of the exemplary embodiments discussed herein. Like directional valves in general, manual three position directional valve 812 may allow breathable air 103 to flow into different paths from one or more ports thereof. Pressure regulating valves 814 may enable emergency personnel 122 to manually select between a number of pressures as per a requirement thereof. For example, pressure regulating valves 814 may control a pressure of breathable air 103 flowing into the different paths from the one or more ports of manual three position directional valve 812.

Pressure gauge 816 may provide emergency personnel 122 with a visual indication of the pressure at which air bottle 270 is being filled. Ports 818₁₋₄ allow up to four fill hoses (e.g., fill hoses 202_{1-L} to be coupled to the manifold (e.g., ports 818₁₋₄) provided through block subassembly 402. Four ports 818₁₋₄ have been shown in FIG. 8 merely for the sake of illustration; example implementations may include anywhere from 1 to any N number of ports. A secondary purpose of ports 818₁₋₄ may be toward maintenance of the component of safety system 100 associated therewith. Last but not the least, one or more gauge ports 820 may be provided as inputs for status visualization/determination of breathable air 103, prediction using the status determination of a characteristic associated with the relevant component and/or preventive maintenance of said relevant component (including fixed piping system 104; or and/or fixed piping system 104) of safety system 100 based on the status visualization/determination and/or prediction.

As shown in FIG. 8, block subassembly 402 may encompass a number of features and elements therewithin with a number of inputs (e.g., via input ports 406₁₋₃) and/or a number of outputs (e.g., via output port 408). The routing of one or more inputs to the one or more outputs may be done with one or more or all of the elements implemented either within block subassembly 402 (e.g., within channel 504/506) or within/on the relevant component of safety system 100. It should be noted that while input 802 is shown as being through input port 406₁₋₃ of block subassembly 402 and other inputs are also possible, the manifold expansion may be accomplished through a number of block subassemblies (e.g., analogous to block subassembly 402). Further, the output of any other component/element discussed in FIG. 8 may be an input through input port 406₁₋₃ that is then routed to one or more output ports of block subassembly 402 and then into the relevant component of safety system 100 wherein one or more other components/elements discussed with reference to FIG. 8 receives said routed input. FIG. 8 also shows output 804 of the configuration as breathable air 103 in any form (high-pressure output as is or modified); output 804 may also be installable at predetermined locations within structure 102/safety system 100 (e.g., associated with emergency air fill stations 120₁₋ₚ). All reasonable variations are within the scope of the exemplary embodiments discussed herein.

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A method of a safety system of a structure having a fixed piping system implemented therein to supply breathable air from a source across the safety system, comprising:
providing a block subassembly comprising at least one input port and at least one output port on a main frame thereof coupled to a component of the safety system; and
routing the breathable air via the at least one input port to the at least one output port on the main frame of the block subassembly and then into the component of the safety system.

2. The method of claim 1, further comprising the component of the safety system being one of: an emergency air fill station configured to provide access to the breathable air from the source therethrough and an air monitoring system configured to monitor the breathable air through the safety system.

3. The method of claim 1, further comprising:
providing perpendicular elements intersecting one another to form a T shape as the main frame of the block subassembly; and
providing the at least one input port and the at least one output port on at least one of the perpendicular elements.

4. The method of claim 3, comprising:
providing an input port of the at least one input port on a first element of the perpendicular elements; and
providing an output port of the at least one output port on a second element perpendicular to the first element of the perpendicular elements.

5. The method of claim 1, further comprising:
providing another input port on the main frame of the block subassembly; and
routing at least one of: an electrical connection and communication within the safety system from the another input port into the component of the safety system.

6. The method of claim 1, comprising the main frame of the block subassembly being made of at least one of: a metal, a metal alloy and a composite material.

7. The method of claim 1, comprising routing the breathable air from the source via the at least one input port to the at least one output port and then into the component of the safety system via a plurality of piping elements.

8. The method of claim 5, further comprising:
providing a first channel within the main frame for the routing of the breathable air from the source via the at least one input port to the at least one output port; and
providing a second channel within the main frame for the routing of the at least one of: the electrical connection and the communication from the another input port into the component of the safety system.

9. The method of claim 1, further comprising utilizing the at least one input port and the at least one output port of the block subassembly to implement at least one of:
an actuated shut-off valve associated with the component to indicate an operational status of at least one of: the component and the breathable air across the safety system;
at least one check valve associated with the component to indicate the operational status of the at least one of: the component and the breathable air across the safety system in a loop piping arrangement of the fixed piping system;
at least one of: a muffled burst disk and a relief valve to protect the component of the safety system against overpressurization due to a pressure differential of the breathable air;
at least one of: a directional valve and a pressure regulating valve to enable at least one of: selection and control of a pressure of the breathable air;
at least one port to allow for at least one fill hose to be coupled thereto to enable filling a breathable air cylinder therefrom; and
at least one gauge port as an input to at least one of: determine status of the breathable air, predict using the status determination a characteristic of the component and perform preventive maintenance of at least one of: the component and the fixed piping system.

10. A component of a safety system of a structure, the component configured to receive breathable air from a source within the safety system via a fixed piping system implemented therein, comprising:
a surface comprising an inlet port; and
a block subassembly comprising a main frame coupled to the surface, the main frame comprising at least one input port and at least one output port provided thereon,
wherein the breathable air from the source is routed through the at least one input port to the at least one output port, and from the at least one output port into the inlet port of the surface.

11. The component of claim 10, wherein:
the main frame of the block subassembly comprises perpendicular elements intersecting one another to form a T shape, and
the at least one input port and the at least one output port are provided on at least one of the perpendicular elements of the main frame.

12. The component of claim 11, wherein:
an input port of the at least one input port is provided on a first element of the perpendicular elements of the main frame, and
an output port of the at least one output port is provided on a second element perpendicular to the first element of the perpendicular elements of the main frame.

13. The component of claim 10, further comprising another input port on the main frame of the block subassembly,
wherein at least one of: an electrical connection and communication within the safety system is routed from the another input port into the component of the safety system.

14. The component of claim 10, wherein the main frame of the block subassembly is made of at least one of: a metal, a metal alloy and a composite material.

15. The component of claim 13, wherein the main frame of the block assembly further comprises:
a first channel therewithin for the routing of the breathable air from the source via the at least one input port to the at least one output port, and
a second channel therewithin for the routing of the at least one of: the electrical connection and the communication from the another input port into the component of the safety system.

16. The component of claim 10, further comprising, implemented utilizing the at least one input port and the at least one output port of the block subassembly, at least one of:
an actuated shut-off valve to indicate an operational status of at least one of: the component and the breathable air;
at least one check valve to indicate the operational status of the at least one of: the component and the breathable air in a loop piping arrangement of the fixed piping system;
at least one of: a muffled burst disk and a relief valve to protect the component against overpressurization due to a pressure differential of the breathable air;
at least one of: a directional valve and a pressure regulating valve to enable at least one of: selection and control of a pressure of the breathable air;
at least one port to allow for at least one fill hose to be coupled thereto to enable filling a breathable air cylinder therefrom; and
at least one gauge port as an input to at least one of: determine status of the breathable air, predict using the status determination a characteristic of the component and perform preventive maintenance of at least one of: the component and the fixed piping system.

17. A safety system of a structure comprising:
a component comprising an inlet port on a surface thereof;
a fixed piping system implemented within the structure for supply of breathable air from a source to the component; and
a block subassembly associated with the component, the block subassembly comprising a main frame coupled to the surface of the component, the main frame comprising at least one input port and at least one output port provided thereon,
wherein the breathable air from the source is routed through the at least one input port to the at least one output port, and from the at least one output port into the inlet port on the surface of the component.

18. The safety system of claim 17, wherein the component of the safety system is one of: an emergency air fill station configured to provide access to the breathable air from the source therethrough and an air monitoring system configured to monitor the breathable air through the safety system.

19. The safety system of claim 17, wherein the block subassembly comprises perpendicular elements intersecting one another to form a T shape provided as the main frame thereof,
wherein the at least one input port and the at least one output port are provided on at least one of the perpendicular elements of the block subassembly.

20. The safety system of claim 19, wherein:
a first element of the perpendicular elements of the block subassembly comprises an input port of the at least one input port provided thereon, and
a second element of the perpendicular elements of the block subassembly perpendicular to the first element thereof comprises an output port of the at least one output port provided thereon.

21. The safety system of claim 17, wherein:
the main frame of the block subassembly further comprises another input port provided thereon, and
at least one of: an electrical connection and communication within the safety system is routed from the another input port into the component of the safety system.

22. The safety system of claim 21, wherein the main frame of the block subassembly further comprises:
a first channel therewithin for the routing of the breathable air from the source via the at least one input port to the at least one output port, and
a second channel therewithin for the routing of the at least one of: the electrical connection and the communication from the another input port into the component of the safety system.

23. The safety system of claim 17, further comprising, implemented utilizing the at least one input port and the at least one output port of the block subassembly, at least one of:
an actuated shut-off valve associated with the component to indicate an operational status of at least one of: the component and the breathable air;
at least one check valve associated with the component to indicate the operational status of the at least one of: the component and the breathable air in a loop piping arrangement of the fixed piping system;
at least one of: a muffled burst disk and a relief valve to protect the component against overpressurization due to a pressure differential of the breathable air;
at least one of: a directional valve and a pressure regulating valve to enable at least one of: selection and control of a pressure of the breathable air;
at least one port to allow for at least one fill hose to be coupled thereto to enable filling a breathable air cylinder therefrom; and
at least one gauge port as an input to at least one of: determine status of the breathable air, predict using the status determination a characteristic of the component and perform preventive maintenance of at least one of: the component and the fixed piping system.
